(19) United States
(12) Patent Application Publication
(10) Pub. No.: US 2023/0234187 A1
(43) Pub. Date: Jul. 27, 2023

(54) PLIERS STRUCTURE

(71) Applicant: Tzu Yu Chen, Taichung City (TW)

(72) Inventor: Tzu Yu Chen, Taichung City (TW)

(21) Appl. No.: 17/585,208

(22) Filed: Jan. 26, 2022

(51) Int. Cl. B25B 7/10

(52) U.S. Cl. CPC B25B 7/10

(57) ABSTRACT

A pliers includes a first pliers body and a second pliers body. The first pliers body includes an upper jaw section, a middle section and a first handle. The second pliers body includes a lower jaw section, a pivotally connected portion and a second handle. A groove including a front arc section close to the upper jaw section and a rear arc section close to the first handle is disposed on the middle section. Centers of curvature corresponding to the front arc section and the rear arc section are located on different sides of the groove. An adjustable button passing through the groove and connected with the first pliers body is disposed on the pivotally connected portion. A clip mouth is defined between the upper jaw section and the lower jaw section. A width of the clip mouth is changeable with a movement of the adjustable button.

### BACKGROUND OF THE INVENTION

### 1. Technical Field

The present invention relates to a hand tool and more particularly to a pair of pliers.

### 2. Description of Related Art

Pliers such as those disclosed in U.S. Pat. No. 8,695,464B2, Germany Patent No. DE102007049032B4 and China Patent No. CN101568408B and CN106103000A commonly include a first pliers body and a second pliers body. A groove is disposed on the first pliers body for an adjustable button passing through and connecting with the second pliers body. When the adjustable button is moved along the groove, the second pliers body moves relative to the first pliers body so that a width of a clip mouth is changed to clip objects with different sizes.

The groove mentioned above, however, is formed in an arc shape. A terminal end of the groove close to the handle leaves away from the clip mouth due to the shape. Hence, as shown in FIG. 6, if the adjustable button 73 reaches the terminal end of the groove 74, the second pliers body 72 is shifted for a small distance to mismatch with the first pliers body 71. The second pliers body 72 engages the object 8 with one single contact, causing the object 8 is not clipped firmly.

Additionally, length of the pliers body depends on maximum size of the object desired to be clipped. But the longer the pliers body is, the more easily the clipped object slips to rotate. If a pair of pliers with a short pliers body is used to clip a big object, the problem that the pliers body engages the object with one single contact occurs.

Each of the conventional structures above-mentioned features teeth structure disposed on the pliers body or in the groove, not helpful to the stability to clip object.

### BRIEF SUMMARY OF THE INVENTION

The primary objective of the present invention is to provide a pliers structure that has a S-shaped groove for moving the pliers body to adjust a width of a clip mouth. Therefore, a position of the pliers body is modified so that objects with different sizes can be clipped firmly.

To achieve the above objective, the present invention provides a pliers that includes a first pliers body and a second pliers body. The first pliers body includes an upper jaw section, a middle section and a first handle integrally connected in sequence. A groove is disposed on the middle section. The groove includes a front arc section close to the upper jaw section and a rear arc section close to the first handle. A second pliers body includes a lower jaw section, a pivotally connected portion and a second handle integrally connected in sequence. The pivotally connected portion is provided with an adjustable button passing through the groove and connected with the first pliers body. A clip mouth is defined between the upper jaw section and the lower jaw section. A width of the clip mouth is changeable with a movement of the adjustable button for driving the second pliers body. A center of curvature corresponding to the front arc section is located on a same side of the groove as the clip mouth. A center of curvature corresponding to the rear arc section is located on an opposite side of the groove which is different from the clip mouth.

Preferably, each of the front arc section and the rear arc section is continuous, and a connecting position of the front arc section and the rear arc section is continuous as well.

Preferably, a side wall of the middle section facing the clip mouth is flat.

Preferably, an angle between the upper jaw section and the side wall is greater than 90 degrees.

### BRIEF DESCRIPTION OF THE SEVERAL VIEWS OF THE DRAWINGS

FIG. 1 is an exploded perspective view of the present invention;

FIG. 2 is a plan view of a part of the first pliers body;

FIG. 3-FIG. 5 illustrate positions of the pliers bodies of the present invention when in use; and

FIG. 6 illustrates positions of the pliers bodies of the conventional pliers when in use.

### DETAILED DESCRIPTION OF THE INVENTION

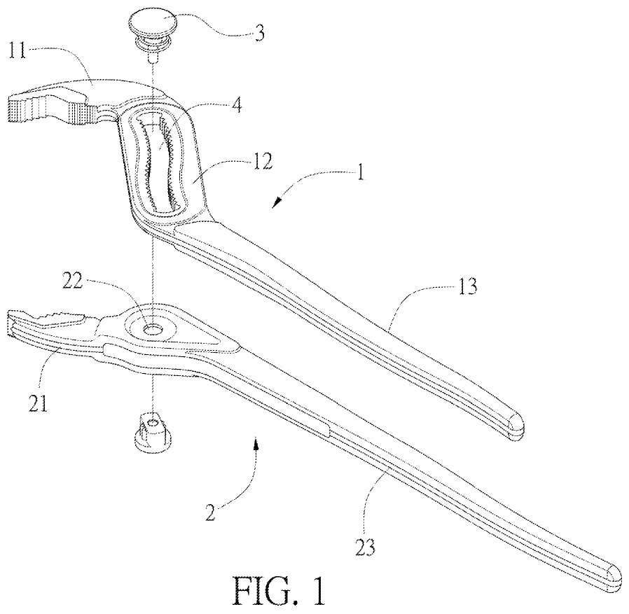

Referring to FIG. 1, the plier structure of the present invention includes a first pliers body 1, a second pliers body 2 and an adjustable button 3.

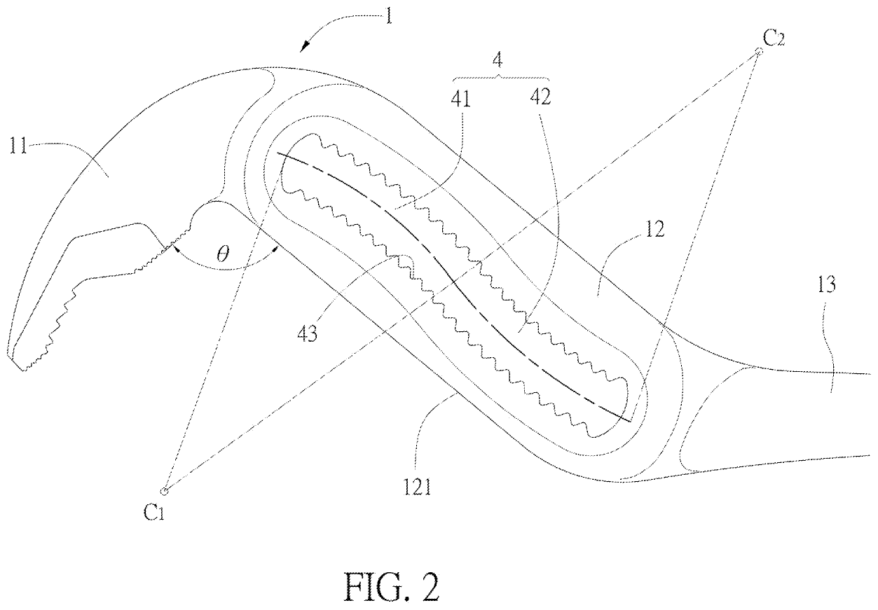

Referring to FIG. 2, the first pliers body 1 includes an upper jaw section 11, a middle section 12 and a first handle 13 integrally connected in sequence. Each of the upper jaw section 11 and the first handle 13 connects the middle section 12 at an angle. In this embodiment, the middle section 12 has a flat side wall 121 facing the upper jaw section 11. An angle between the upper jaw section 11 and the side wall 121 is greater than 90 degrees.

A curved groove 4 is disposed on the middle section 12. The groove 4 includes a front arc section 41 close to the upper jaw section 11 and a rear arc section 42 close to the first handle 13. Both the front arc section 41 and the rear arc section 42 are continuous, and a connecting position of the front are section 41 and the rear arc section 42 is continuous as well. A center of curvature C1 corresponding to the front arc section 41 is defined on a side of the groove 4 while a center of curvature C2 corresponding to the rear arc section 42 is defined on an opposite side of the groove 4. In this embodiment, the center of curvature C1 corresponding to the front arc section 41 is located on a same side of the groove as the upper jaw section 11. The center of curvature C2 corresponding to the rear arc section 42 is located on a same side of the groove 4 as the first handle 13. Accordingly, the entire groove 4 is formed in a shape of S. There are teeth 43 disposed in the groove 4.

The second pliers body 2 includes a lower jaw section 21, a pivotally connected portion 22 and a second handle 23 integrally connected in sequence. The adjustable button 3 couples with the pivotally connected portion 22, passes through the groove 4 and engages with the teeth 43 so that the second pliers body 2 is able to pivot against the adjustable button 3.

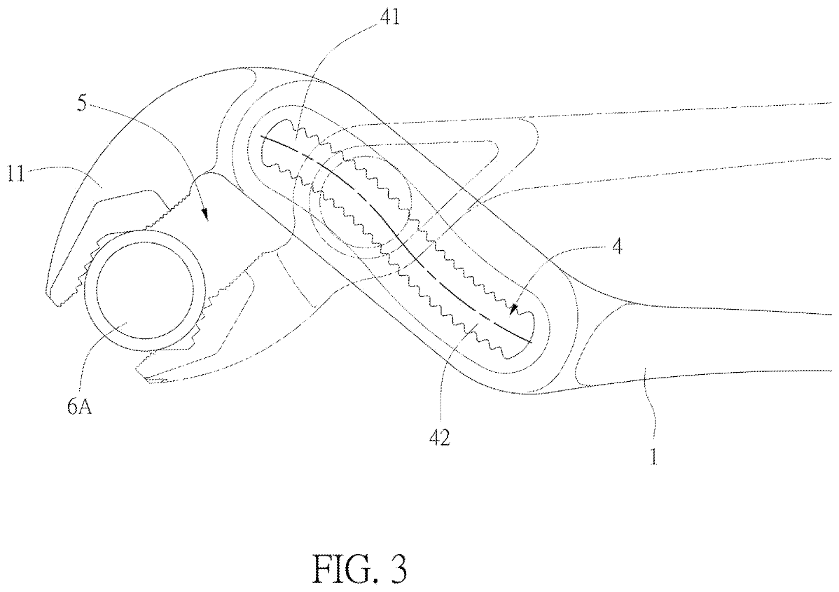

Referring to FIG. 3, a clip mouth 5 is defined between the upper jaw section 11 and the lower jaw section 21, and a width of the clip mouth 5 can be changed. As long as the adjustable button 3 is manipulated to move along the groove 4, thereby driving the second pliers body 2 to move relative to the first pliers body 1, the distance between the upper jaw section 11 and the lower jaw section 21 can be adjusted.

In a case that an object 6A in a small size is clipped, as shown in FIG. 3, the adjustable button 3 is moved into the front arc section 41, then the lower jaw section 21 is moved to a corresponding position, so the width of the clip mouth 5 fits the clipped object 6A. Although the lower jaw section 21 is shifted backward to slightly leave away from the upper jaw section 11 due to the shape of the front arc section 41, the lower jaw section 21 still can engage the object 6A with two contacts for firmly clipping as the upper jaw section 11 does.

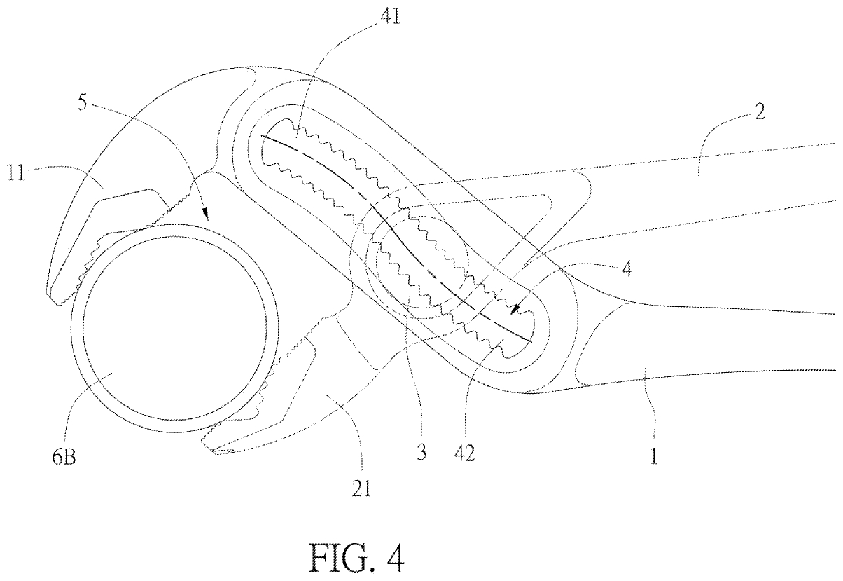

In a case that an object 6B in a larger size is clipped, as shown in FIG. 4, the adjustable button 3 is moved close to an interconnection of the front arc section 41 and the rear arc section 42, then the lower jaw section 21 is moved to a corresponding position, so the width of the clip mouth 5 fits the clipped object 6B. Although the lower jaw section 21 is shifted forward to slightly approach the upper jaw section 11, the lower jaw section 21 still can engage the object 6B with two contacts for firmly clipping as the upper jaw section 11 does.

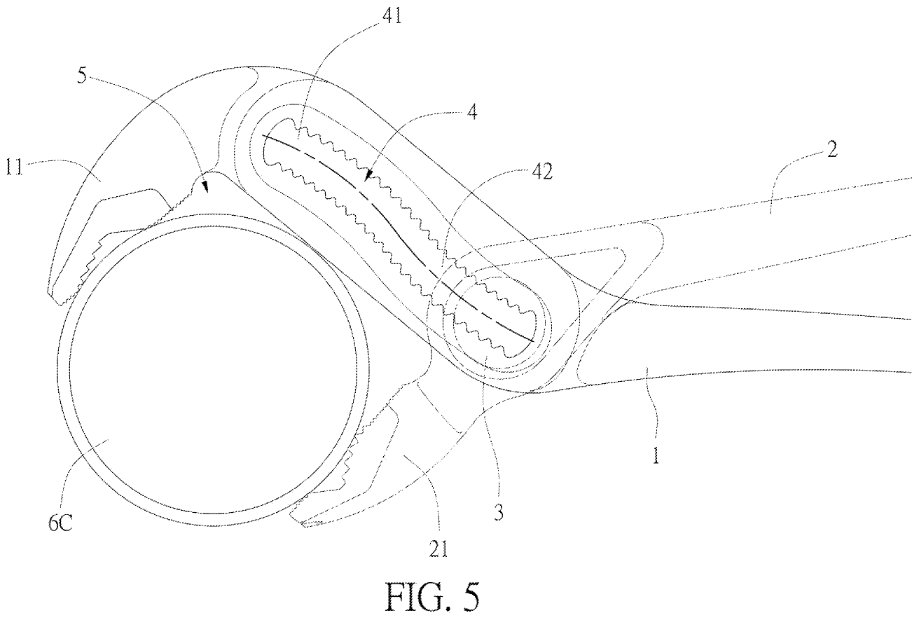

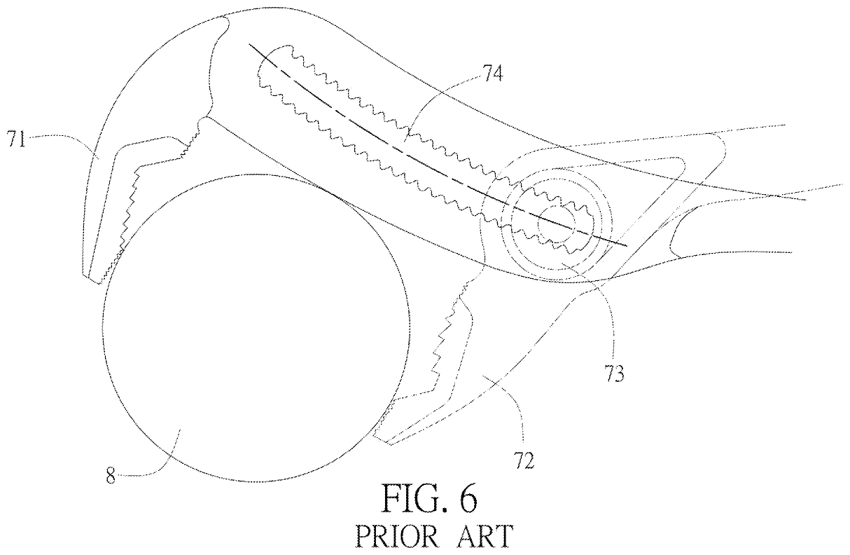

In a case that an object 6C in a much larger size is clipped, as shown in FIG. 5, the adjustable button 3 is moved into the rear arc section 41, then the lower jaw section 21 is moved to a corresponding position, so the width of the clip mouth 5 fits the clipped object 6C. Although the lower jaw section 21 is shifted backward to slightly leave away from the upper jaw section 11 due to the shape of the rear arc section 41, the lower jaw section 21 still can engage the object 6C with two contacts for firmly clipping as the upper jaw section 11 does.

What is claimed is:

1. A pliers comprising:
a first pliers body including an upper jaw section, a middle section and a first handle integrally connected in sequence;
a groove disposed on the middle section, the groove including a front arc section close to the upper jaw section and a rear arc section close to the first handle;
a second pliers body including a lower jaw section, a pivotally connected portion and a second handle integrally connected in sequence, the pivotally connected portion being provided with an adjustable button passing through the groove and connected with the first pliers body, a clip mouth being defined between the upper jaw section and the lower jaw section, a width of the clip mouth being changeable with a movement of the adjustable button for driving the second pliers body;
wherein a center of curvature corresponding to the front arc section is located on a same side of the groove as the clip mouth, while a center of curvature corresponding to the rear arc section is located on an opposite side of the groove which is different from the clip mouth.

2. The pliers of claim 1, wherein each of the front arc section and the rear arc section is continuous, and a connecting position of the front arc section and the rear arc section is continuous as well.

3. The pliers of claim 1, wherein a side wall of the middle section facing the clip mouth is flat.

4. The pliers of claim 3, wherein an angle between the upper jaw section and the side wall is greater than 90 degrees.
